(19) United States
(12) Patent Application Publication
(10) Pub. No.: US 2007/0085372 A1
(43) Pub. Date: Apr. 19, 2007

(54) Snow and ice repelling vehicle cover

(76) Inventor: Bhanu Dhanray, Norwalk, CT (US)

Correspondence Address: LAW OFFICE OF MICHAEL A. BLAKE, 112 BROAD STREET, MILFORD, CT, 06460, US

(21) Appl. No.: 11/251,162

(22) Filed: Oct. 14, 2005

(51) Int. Cl. B60J 7/20

(52) U.S. Cl. 296/136.07

(57) ABSTRACT

A snow and ice repelling vehicle cover comprising: a hood panel configured to cover a hood of a vehicle; a hood panel attachment means coupled to the hood panel and configured to removably attach the hood panel to the vehicle; a windshield panel configured to cover a windshield of a vehicle; a windshield panel attachment means coupled to the windshield panel and configured to removably attach the windshield panel to the vehicle; a roof panel configured to cover a roof of a vehicle; a roof panel attachment means coupled to the roof panel and configured to removably attach the roof panel to the vehicle; and where each panel is configured such that when slid off of the underlying vehicle surface, the underlying vehicle surface is left relatively clear of snow and ice. A snow and ice repelling vehicle cover comprising: a hood panel configured to cover a hood of a vehicle; a hood panel attachment means coupled to the hood panel and configured to removably attach the hood panel to the vehicle; a windshield panel configured to cover a windshield of a vehicle; a windshield panel attachment means coupled to the windshield panel and configured to removably attach the windshield panel to the vehicle; a roof panel configured to cover a roof of a vehicle; a roof panel attachment means coupled to the roof panel and configured to removably attach the roof panel to the vehicle; a rear window panel configured to cover a rear window of a vehicle; a rear window panel attachment means coupled to the rear window panel and configured to removably attach the rear window panel to the vehicle; a rear panel configured to cover a rear portion of a vehicle; and a rear panel attachment means coupled to the rear panel and configured to removably attach the rear panel to the vehicle.

### TECHNICAL FIELD

This invention relates generally to covers for motor vehicles and in particular to a motor vehicle cover comprising a plurality of panels.

### BACKGROUND

Vehicle covers have been used to protect parked or stored vehicles from damage caused by environmental and weather conditions such as solar radiation, heat, pollution, dust, acid rain, sleet, hail, and flying objects which may be encountered during violent or severe weather. Although existing vehicle covers adequately protect against some of those conditions, most are not very effective at quickly removing snow and ice from the exterior of a vehicle. Those covers which do protect against snow are usually configured to also prevent damage to the exterior of the vehicle from hailstones and other hard objects. Those covers which are designed to protect against such hard objects are bulky and cumbersome, making installation and removal an arduous and time consuming process. Moreover, such covers are typically difficult to store due to their bulk.

Various types of vehicle covers have been proposed. Prior art approaches include a cover constructed of canvas or nylon and having a means for securing the cover to the vehicle such as an elastic band extending about its periphery or hooks for attaching to a vehicle. Those designs suffer in that they are difficult and time consuming to install on and a remove from a vehicle.

Another prior art vehicle cover provides for the use of an inflatable air chamber or a plurality of such chambers which envelop the vehicle when the cover is installed on the vehicle. That approach requires a source of compressed air to inflate the chamber(s), and the inflated chambers are cumbersome and bulky. Moreover, inflating and deflating such covers tends to be a labor intensive and time consuming process.

Accordingly, there is a need for a new and improved vehicle protective cover configured to protect vehicles from snow and ice, and which allows a user to quickly remove snow and ice from the exterior of a vehicle.

### SUMMARY

The disclosed apparatus relates to a snow and ice repelling vehicle cover comprising: a hood panel configured to cover a hood of a vehicle; a hood panel attachment means coupled to the hood panel and configured to removably attach the hood panel to the vehicle; a windshield panel configured to cover a windshield of a vehicle; a windshield panel attachment means coupled to the windshield panel and configured to removably attach the windshield panel to the vehicle; a roof panel configured to cover a roof of a vehicle; a roof panel attachment means coupled to the roof panel and configured to removably attach the roof panel to the vehicle; and where each panel is configured such that when slid off of the underlying vehicle surface, the underlying vehicle surface is left relatively clear of snow and ice.

The disclosed apparatus also relates to a snow and ice repelling vehicle cover comprising: a hood panel configured to cover a hood of a vehicle; a hood panel attachment means coupled to the hood panel and configured to removably attach the hood panel to the vehicle; a windshield panel configured to cover a windshield of a vehicle; a windshield panel attachment means coupled to the windshield panel and configured to removably attach the windshield panel to the vehicle; a roof panel configured to cover a roof of a vehicle; a roof panel attachment means coupled to the roof panel and configured to removably attach the roof panel to the vehicle; a rear window panel configured to cover a rear window of a vehicle; a rear window panel attachment means coupled to the rear window panel and configured to removably attach the rear window panel to the vehicle; a rear panel configured to cover a rear portion of a vehicle; and a rear panel attachment means coupled to the rear panel and configured to removably attach the rear panel to the vehicle.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a perspective view of one embodiment of a vehicle and the disclosed vehicle cover;

FIG. 2 is a perspective view of the disclosed vehicle cover being installed on the vehicle;

FIG. 3 is a perspective view of the disclosed vehicle cover installed on the vehicle; and

FIG. 4 is a perspective view of one panel from the disclosed vehicle cover.

### DETAILED DESCRIPTION

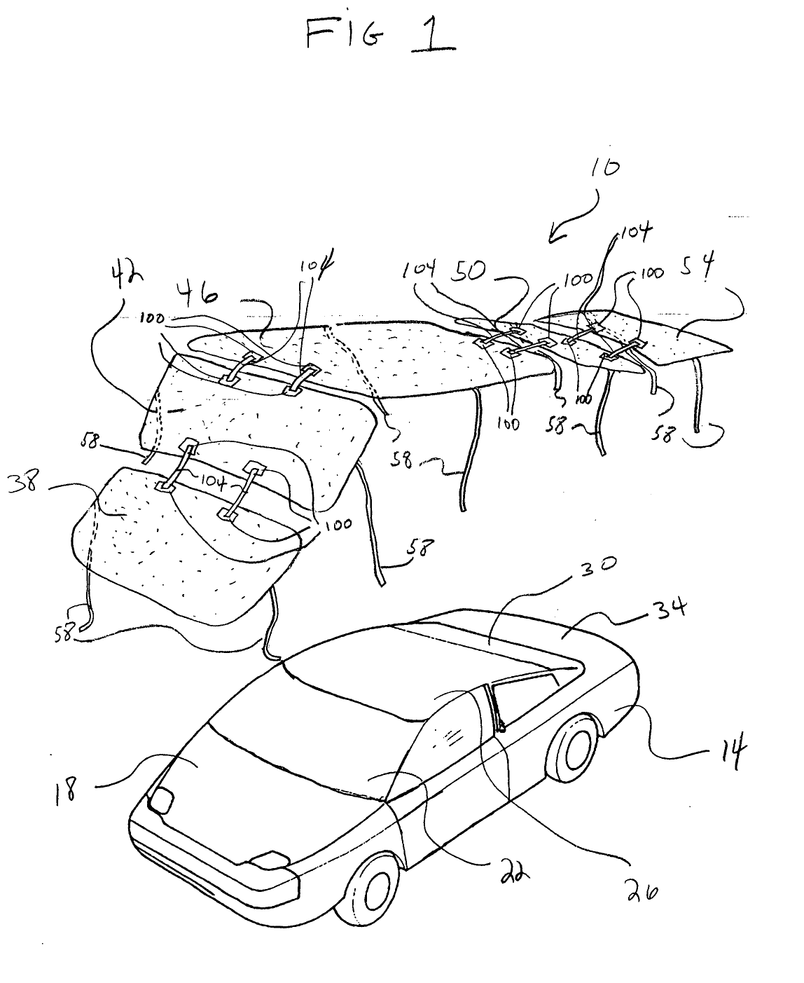

FIG. 1 shows a perspective view of the disclosed vehicle cover 10 near a vehicle 14. The vehicle 14 may be a typical automobile with a hood 18, windshield 22, roof 26, rear window 30 and rear 34. In one embodiment the vehicle cover 10 comprises five panels 38, 42, 46, 50, and 54. The first panel 38 is sized to cover the hood 18, the second panel 42 is sized to cover the windshield 22, the third panel 46 is sized to cover the roof 26, the fourth panel 50 is sized to cover the rear window 30, and the fifth panel 54 is sized to cover the rear 34 of the vehicle 14. Each of the panels 38, 42, 46, 50, 54 have at least two flexible members 58. The flexible members 58 may be comprised of any suitable material, including, but not limited to: lengths of cord, lengths of rope, or nylon straps, lengths of string, lengths of twine, bungee cords, and plastic straps. The panels 38, 42, 46, 50, 54 may also have a plurality of attachment surfaces 100 located on each panel 38, 42, 46, 50, 54. The attachment surfaces 100 are configured to allow an attaching strap 104 to couple to two attachment surfaces 100 on adjacent panels. The attachment surfaces 100 and attaching straps 104 may use the following as an attaching means: Velcro, snaps, buttons, hooks. Of course, the attaching surfaces 100, and attaching straps 104 may be omitted in other embodiments of the disclosed vehicle cover.

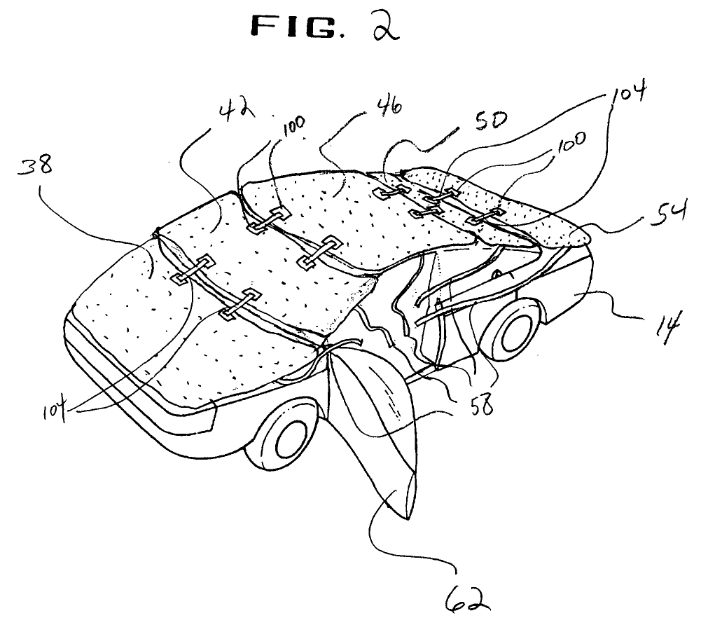

FIG. 2 shows the panels 38, 42, 46, 50, and 54 on the car 14. The flexible members 58 are configured to be long enough to be placed inside the car via an open door 62, or window, and when the door or window is closed, the panels will be held in place by the flexible members 58, and not blow away or otherwise move from the vehicle.

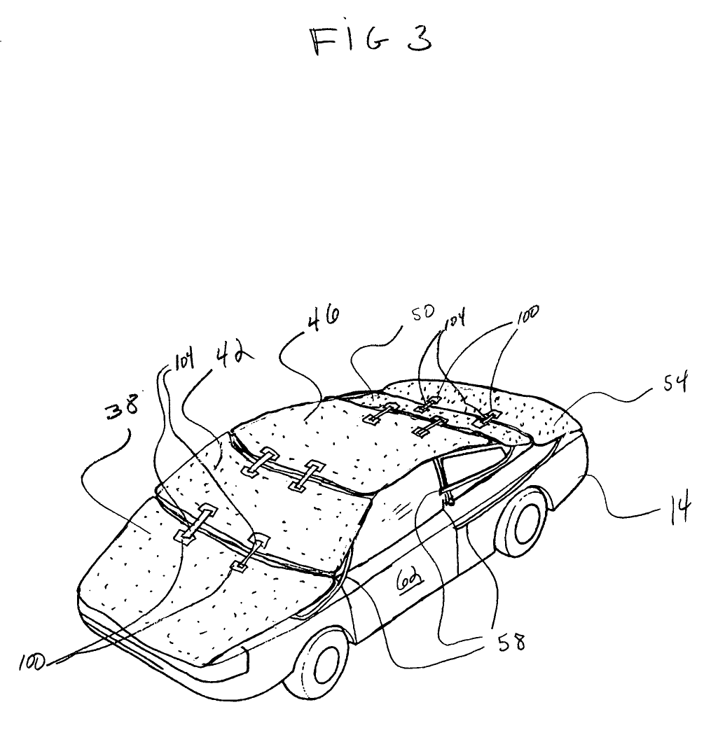

FIG. 3 shows the vehicle cover 10 installed on a vehicle 14, with the flexible members 58 inside the car door 62. Thus, when the vehicle is parked outside, with the vehicle cover installed, and snow and ice builds up on the vehicle, instead of spending time scraping ice and snow off of the car, one need only to open his or her vehicle door (or window) and remove the panels. The panels have the snow and ice on them, keeping the hood 18, windshield 22, roof 26, rear window 30 and rear 34 of the vehicle generally clear of snow and ice. This will save time, since scraping of ice and snow will be eliminated. Additionally, sliding the panels off of the car, instead of scraping snow and ice, will keep the user relatively free of getting snow and ice all over his or her person, thereby keeping the user clean and ready for work, school, church, etc. Also, because the panels keep the windshield and rear window protected from snow and ice, the windows will be clear of snow and ice, and the need to drive with an obscured windshield and rear window that has been poorly and/or quickly scraped will be removed. Additionally, it will be less likely that there will be an amount of snow or ice left on the vehicle, such as when the vehicle is moving on the road, ice and snow will blow off the vehicle and either obscure the driver's view, or impinge on an other vehicle on the road. Also, the disclosed vehicle cover is not bulky, and is easily stored in a relatively small space.

In another embodiment, one or more suction cups may be located on an inner surface of each panel. Thus, each panel may be attached to the surface of the vehicle by attaching the suction cup to the vehicle. In such and embodiment, the suction cups may replace the flexible members 58. It should be noted, that the five panels 38, 42, 46, 50 and 54 may sold in sets. Additionally, the panels may be configured to fit onto small vehicles, medium sized vehicle, large vehicles, and commercial vehicles (such as tractor trailers). Additionally, some vehicles may not require 5 panels, but rather may only need 4 or 3 panels. Such vehicles may include but are not limited to: hatchbacks, motorcycles, scooters and mopeds.

Since no hooks or straps tied to or wrapped around the vehicle are required, the panels are easy to remove from the vehicle. The panels may be easily slid off the vehicle, taking the snow and ice off of the vehicle once the doors and/or windows are opened.

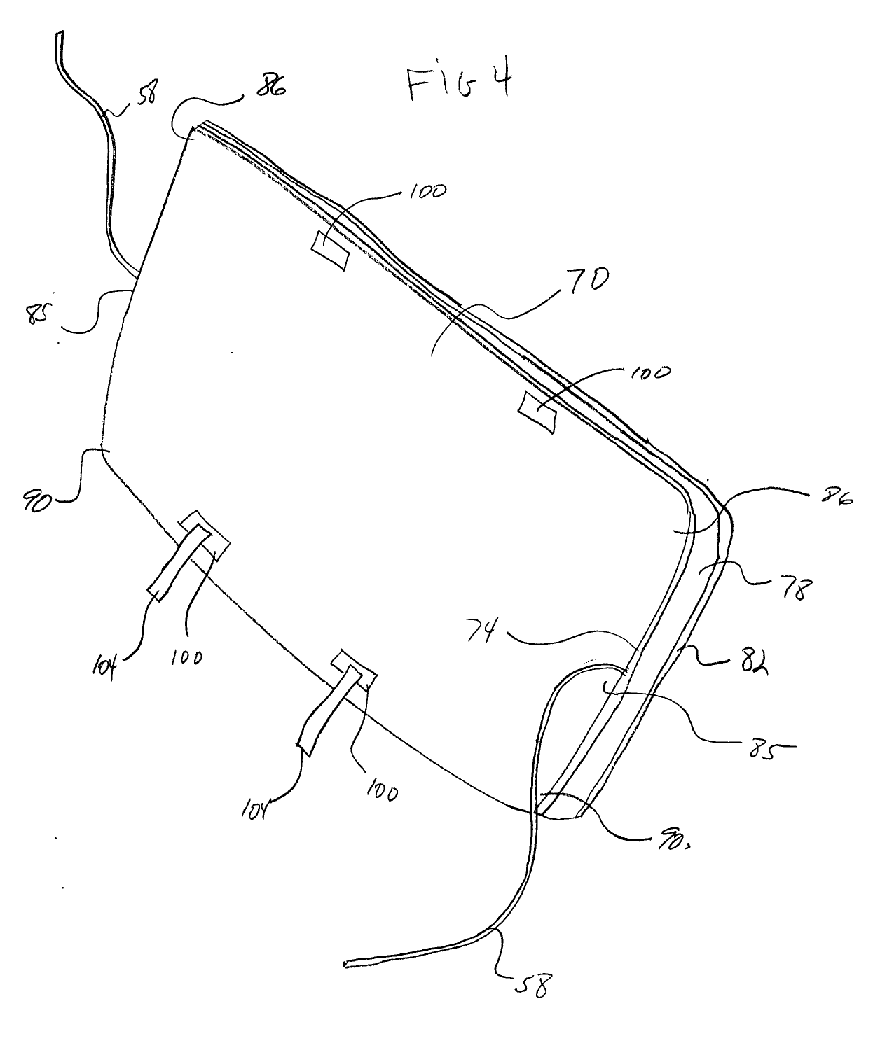

FIG. 4 shows a perspective view of one panel 70 that makes up the vehicle cover 10. The panel may comprise three layers. An outer layer 74, a middle layer 78 and an inner layer 82. The outer layer may be made from any water proof material, such as, but not limited to plastic, nylon, and rubber. The middle layer may 78 may be made from a material that provides an amount of stiffness to the panel. Such material may include, but is not limited to: foam, rubber, nylon, plastic, carbon composite. The panels should be stiff enough such that the will hold their shape, for easy transport and storage. The inner layer may be made from any non-stick material, including, but not limited to: wax paper, Teflon coated material, Calphalon LRS coated material, Calphalon LRS3 coated material, and nonstick polypropylene. The flexible members 58 are shown attached to the panel near the center 85 of each side of the panel 70. However, in other embodiments, the flexible members 58 may be attached elsewhere on the panel in order to compensate for the geometry of the vehicle, such that the panels will be more likely to stay in place on the vehicle, for example, the flexible panels may be attached near the top 86 of the panel 70, or near the bottom of the panel 90. Also shown are the attaching surfaces 100 and attaching straps 104.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A snow and ice repelling vehicle cover comprising:
a hood panel configured to cover a hood of a vehicle;
a hood panel attachment means coupled to the hood panel and configured to removably attach the hood panel to the vehicle;
a windshield panel configured to cover a windshield of a vehicle;
a windshield panel attachment means coupled to the windshield panel and configured to removably attach the windshield panel to the vehicle;
a roof panel configured to cover a roof of a vehicle;
a roof panel attachment means coupled to the roof panel and configured to removably attach the roof panel to the vehicle; and
wherein each panel is configured such that when slid off of the underlying vehicle surface, the underlying vehicle surface is left relatively clear of snow and ice.

2. The snow and ice repelling vehicle cover of claim 1, further comprising:
a rear window panel configured to cover a rear window of a vehicle; and
a rear window panel attachment means coupled to the rear window panel and configured to removably attach the rear window panel to the vehicle.

3. The snow and ice repelling vehicle cover of claim 1, further comprising:
a rear panel configured to cover a rear portion of a vehicle; and
a rear panel attachment means coupled to the rear panel and configured to removably attach the rear panel to the vehicle.

4. The snow and ice repelling vehicle cover of claim 1, wherein each of the attachment means comprise a plurality of flexible members.

5. The snow and ice repelling vehicle cover of claim 4, wherein at least one flexible member is configured to attach a panel to the vehicle by closing a vehicle door on the flexible member such that a portion of the flexible member is inside the vehicle and a portion of the flexible member is outside of the vehicle.

6. The snow and ice repelling vehicle cover of claim 4, wherein at least one flexible member is configured to attach a panel to the vehicle by closing a vehicle window on the flexible member such that a portion of the flexible member is inside the vehicle and a portion of the flexible member is outside of the vehicle.

7. The snow and ice repelling vehicle cover of claim 4, wherein the flexible member is made from a material selected from the group consisting of lengths of cord, lengths of rope, nylon straps, lengths of string, lengths of twine, bungee cords, and plastic straps.

8. The snow and ice repelling vehicle cover of claim 1, wherein each panel comprises:
an outer layer that is water proof;
a middle layer adjacent to the outer layer, wherein the middle layer comprises a material that provides stiffness to the panel;
an inner layer adjacent to the middle layer, wherein the inner layer comprises a non-stick material.

9. The snow and ice repelling vehicle cover of claim 1, wherein the outer layer is made from a material selected from the group consisting of plastic, nylon, and rubber.

10. The snow and ice repelling vehicle cover of claim 1, wherein the middle layer is made from a material selected from the group consisting of foam, rubber, nylon, plastic, carbon composite.

11. The snow and ice repelling vehicle cover of claim 1, wherein the inner layer is made from a material selected from the group consisting of wax paper, Teflon coated material, Calphalon LRS coated material, Calphalon LRS3 coated material, and nonstick polypropylene.

12. The snow and ice repelling vehicle cover of claim 1, wherein each of the attachment means comprise at least one suction cup located on an inner layer of the panel.

13. The snow and ice repelling vehicle cover of claim 1, wherein each panel also comprises at least one attaching surface.

14. The snow and ice repelling vehicle cover of claim 13, further comprising:
an attaching strap configured to attach to two attaching surfaces of adjacent panels.

15. A snow and ice repelling vehicle cover comprising:
a hood panel configured to cover a hood of a vehicle;
a hood panel attachment means coupled to the hood panel and configured to removably attach the hood panel to the vehicle;
a windshield panel configured to cover a windshield of a vehicle;
a windshield panel attachment means coupled to the windshield panel and configured to removably attach the windshield panel to the vehicle;
a roof panel configured to cover a roof of a vehicle;
a roof panel attachment means coupled to the roof panel and configured to removably attach the roof panel to the vehicle;
a rear window panel configured to cover a rear window of a vehicle;
a rear window panel attachment means coupled to the rear window panel and configured to removably attach the rear window panel to the vehicle;
a rear panel configured to cover a rear portion of a vehicle; and
a rear panel attachment means coupled to the rear panel and configured to removably attach the rear panel to the vehicle.

16. The snow and ice repelling vehicle cover of claim 15, wherein each panel also comprises at least one attaching surface.

17. The snow and ice repelling vehicle cover of claim 16, further comprising:
an attaching strap configured to attach to two attaching surfaces of adjacent panels.
